(19) United States
(12) Patent Application Publication
(10) Pub. No.: US 2024/0204364 A1
(43) Pub. Date: Jun. 20, 2024

(54) BATTERY CELL MODULE COMPRISING BATTERY CELLS ELECTRICALLY COUPLED IN PARALLEL FOR BALANCING

(71) Applicant: Scania CV AB, Södertälje (SE)

(72) Inventor: Lianhao YIN, Stockholm (SE)

(73) Assignee: Scania CV AB, Södertälje (SE)

(21) Appl. No.: 18/278,757

(22) PCT Filed: Feb. 18, 2022
(86) PCT No.: PCT/SE2022/050177

§ 371 Date: Aug. 24, 2023

(30) Foreign Application Priority Data
Mar. 5, 2021 (SE) 2150256-2

(51) Int. Cl. H01M 50/512; H01M 50/209

(52) U.S. Cl. CPC H01M 50/512; H01M 50/209; H01M 2220/20

(57) ABSTRACT

The invention is related to a battery cell module comprising two end battery cells and a number of intermediate battery cells arranged between the two end battery cells to form a row of battery cells. At least one of the two end battery cells is electrically coupled in parallel with at least one intermediate battery cell, allowing state-of-charge of the parallel coupled battery cells to be balanced. Thereby, achieving an improved balancing which can reduce uneven aging of the battery cells in the battery cell module and increase the life-length of the battery cell module.

### CROSS-REFERENCE TO RELATED APPLICATIONS

This application is a National Stage Patent Application (filed under 35 § U.S.C. 371) of PCT/SE2022/050177, filed Feb. 18, 2022, of the same title, which, in turn claims priority to Swedish Patent Application No. 2150256-2 filed Mar. 5, 2021, of the same title; the contents of each of which are hereby incorporated by reference.

### FIELD OF THE INVENTION

Aspects of the present invention relate to a battery cell module where at least one of two end battery cells is electrically coupled in parallel with at least one intermediate battery cell.

### BACKGROUND

An electric battery cell can be seen as a container chemically storing energy. The electric battery cells may come in various forms and shapes. The electric battery cells may be connected in series and in parallel to form a battery cell module. Several battery cell modules may in turn be integrated into an electric battery arrangement, which may be called an electric battery pack, in order to attain the desired voltage and energy capacity. A conventional electric battery pack may be the complete enclosure or unit that delivers electric power to a product or equipment, for example an electrical vehicle or a hybrid vehicle. When used in a hybrid vehicle or an electric vehicle, the electric battery pack may be connected to a vehicle electrical system of the vehicle, which may be called a vehicle high voltage system (VCB). The vehicle electrical system transfers electric power or electric current between various electrical apparatuses or units included in the hybrid vehicle or the electric vehicle.

### SUMMARY

An object of embodiments of the invention is to provide a solution which mitigates or solves drawbacks and problems of conventional solutions.

A further object of embodiments of the invention is to provide a solution which compensates for different aging speed of battery cells in battery cell modules.

The above and further objects are solved by the subject matter of the independent claim. Further advantageous embodiments of the invention can be found in the dependent claims.

According to a first aspect of the invention, the above mentioned and other objects are achieved with a battery cell module comprising two end battery cells and a number of intermediate battery cells arranged between the two end battery cells to form a row of battery cells, wherein at least one of the two end battery cells is electrically coupled in parallel with at least one intermediate battery cell and wherein the row of battery cells comprises two or more remaining battery cells being electrically coupled in series with each other.

An advantage of the battery cell module according to the first aspect is that it allows differences in state-of-charge between an edge battery cell and an intermediate battery cell to be balanced. Thereby, reducing differences in aging speed within the battery cell module and improving the life-length of the battery cell module. With the parallel coupling between edge and intermediate battery cells the state-of-charge can be balanced even when the battery capacity of the edge and intermediate battery cells are different. Furthermore, it allows a parallel coupled battery cell to easily be changed if broken, as the difference in battery capacity between the new battery cell and the rest of the battery cells in the battery cell module can be balanced.

According to an embodiment of the battery cell module according to the first aspect, the two end battery cells are electrically coupled in parallel with at least one intermediate battery cell.

An advantage of this embodiment is that both end battery cells can be used for balancing, providing an efficient and flexible balancing.

According to an embodiment of the battery cell module according to the first aspect, the two end battery cells are electrically coupled in parallel with the same or different intermediate battery cells.

An advantage of this embodiment is that the balancing can be implemented in a flexible way.

According to an embodiment of the battery cell module according to the first aspect, the battery cell module comprises at least two intermediate battery cells arranged between the two end battery cells to form the row of battery cells, and wherein all remaining battery cells of the row of battery cells are electrically coupled in series with each other.

An advantage of this embodiment is that a high voltage battery cell module can be provided while providing conditions for an efficient balancing of battery cells to thereby reduce differences in aging speed within the battery cell module and improving the life-length of the battery cell module.

According to an embodiment of the battery cell module according to the first aspect, at least one of the two end battery cells is electrically coupled in parallel with at least one center battery cell.

An advantage of this embodiment is that an efficient balancing can be provided.

According to an embodiment of the battery cell module according to the first aspect, an intermediate battery cell closer to an end battery cell is electrically coupled in parallel with an intermediate battery cell closer to a center battery cell.

An advantage of this embodiment is that further battery cells in the battery cell module can be balanced, improving the overall balancing.

According to an embodiment of the battery cell module according to the first aspect, the row of battery cells comprises an even number of battery cells.

An advantage of this embodiment is that an efficient balancing can be provided.

According to an embodiment of the battery cell module according to the first aspect, a spatial distance between two adjacent battery cells varies in the row of battery cells.

An advantage of this embodiment is that the spatial distance between two adjacent battery cells can be adapted to reduce stress interaction between adjacent battery cells and thereby the aging speed.

According to an embodiment of the battery cell module according to the first aspect, the spatial distance between two adjacent battery cells is dependent on the distance to the end battery cells.

An advantage of this embodiment is that the spatial distance between two adjacent battery cells can be adapted based on the position of the two adjacent battery cells relative to the end battery cells in the battery module. Thereby, efficiently reducing the stress interaction between the battery cells in the battery cell module.

According to an embodiment of the battery cell module according to the first aspect, the spatial distance between two adjacent battery cells decreases towards the end battery cells.

An advantage of this embodiment is that a larger spatial distance can be provided between battery cells further away from the end battery cells, i.e. battery cells exposed to higher stress and hence more swelling. Thereby, efficiently reducing the stress interaction between the battery cells in the battery cell module.

According to an embodiment of the battery cell module according to the first aspect, the battery cells of the battery cell module are prismatic battery cells.

An advantage of this embodiment is that an efficient way to balance and reduce stress interaction between prismatic cells can be provided.

The above-mentioned features and embodiments of the battery cell module may be combined in various possible ways providing further advantageous embodiments.

According to a second aspect of the invention, the above mentioned and other objects are achieved with a vehicle comprising a battery cell module according to any one of the embodiments of the battery cell module according to the first aspect.

An advantage of vehicle according to the second aspect is that the battery capacity of the vehicle can be improved as the battery cell module has an increased life-length.

According to a third aspect of the invention, the above mentioned and other objects are achieved with a method for coupling battery cells of a battery cell module comprising two end battery cells and a number of intermediate battery cells arranged between the two end battery cells to form a row of battery cells, the method comprising:
electrically coupling least one of the two end battery cells in parallel with at least one intermediate battery cell; and
electrically coupling two or more remaining battery cells of the row of battery cells in series with each other.

According to an embodiment of the method according to the third aspect, the method further comprises:
arranging the battery cells so that a spatial distance between two adjacent battery cells varies in the row of battery cells.

It will be appreciated that all the embodiments described for the battery cell module aspects of the invention are applicable also to the method aspect of the invention. Thus, the method according to the third aspect can be extended into embodiments corresponding to the embodiments of the battery cell module according to the first aspect. The method and its embodiments have advantages corresponding to the advantages mentioned above for the battery cell module and its embodiments.

Further embodiments of the battery cell module, the vehicle, and the method according to the present invention and further advantages with the embodiments of the present invention emerge from the detailed description hereinbelow.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIGS. 1-6 schematically illustrate battery cell modules according to embodiments of the invention;

FIG. 7 schematically illustrates a flow chart of a method according to an embodiment of the invention; and

FIG. 8 schematically illustrates a vehicle comprising a battery cell module according to an embodiment of the invention.

### DETAILED DESCRIPTION

Battery cells used in hybrid vehicle and electric vehicle are usually prismatic cells. Prismatic cells can be arranged in battery cell modules to provide large capacity while optimizing the use of space. However, the flat shape of prismatic cells increases the contact surface between battery cells and can lead to high stress pressure on the prismatic battery cells in a battery cell module.

Furthermore, the stress pressure can be uneven within a battery cell module. Battery cells arranged in the middle of the battery cell module can experience a higher stress pressure than battery cells arranged at the end/edge of the battery cell module. As the stress pressure has significant influence on the aging of a battery cell, the uneven stress pressure can lead to a faster aging of the battery cells arranged in the middle of the battery cell module. This may in turn cause a reduced life-length of the battery cell module.

Conventional solutions to compensate for different aging speed of battery cells in battery cell modules are based on complex balancing systems balancing the state-of-charge between battery cells in the middle and at the edge of the battery cell module. However, the battery cells may become so unbalanced that the balancing system can no longer balance them which can lead to different state-of-charge windows for the battery cells in the battery cell module.

According to embodiments of the invention a battery cell module where differences in state-of-charge between battery cells can be balanced based on parallel coupling of battery cells based on their position in the battery cell module is therefore provided. The parallel coupling according to the invention provides an efficient balancing which can reduce differences in aging speed within the battery cell module and improving the life-length of the battery cell module.

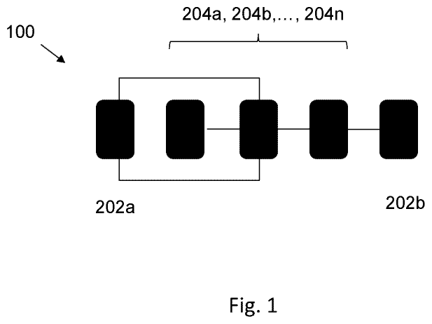

FIG. 1 schematically illustrates a battery cell module 100 according to an embodiment of the invention. The battery cell module 100 comprises two end battery cells 202a, 202b and one or more intermediate battery cells 204a, 204b, . . . , 204n arranged between the two end battery cells 202a, 202b to form a row of battery cells. Each battery cell can be seen as a container chemically storing energy and may be a rechargeable electric battery cell. The battery cell may for example be a Li-ion battery cell or a NiMH battery cell but are not limited thereto. The battery cells of the battery cell module 100 may further be prismatic battery cells.

At least one of the two end battery cells 202a, 202b is electrically coupled in parallel with at least one intermediate battery cell 204a, 204b, . . . , 204n and wherein the row of battery cells comprises two or more remaining battery cells being electrically coupled in series with each other.

With reference to FIG. 1, one end battery cell 202a is electrically coupled in parallel with one of the intermediate battery cell 204a, 204b, . . . , 204n. Furthermore, all the intermediate battery cells 204a, 204b, 204c and another end battery cell 202b may be electrically coupled in series with each other. The parallel coupling between the one end battery cell 202a and the intermediate battery cell 204n allows the state-of-charge of these battery cells to be balanced. As the stress pressure on end battery cells typically is smaller than on intermediate battery cells which can lead to different state-of-charge, the parallel coupling between the one end battery cell 202a and the intermediate battery cell 204n provides an efficient balancing.

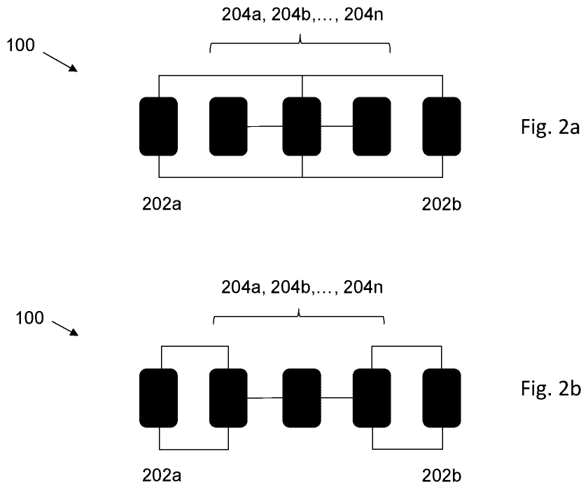

In embodiments, the two end battery cells 202a, 202b are electrically coupled in parallel with at least one intermediate battery cell 204a, 204b, . . . , 204n. Thus, both end battery cells 202a, 202b may be electrically coupled in parallel with an intermediate battery cell 204a, 204b, . . . , 204n. The two end battery cells 202a, 202b may be electrically coupled in parallel with the same or different intermediate battery cells 204a, 204b, . . . , 204n, as schematically illustrated in FIG. 2a and FIG. 2b.

In FIG. 2a, the two end battery cells 202a, 202b are electrically coupled in parallel with the same intermediate battery cells 204n and the intermediate battery cells 204a, 204b, . . . , 204n are all coupled in series with each other. In FIG. 2b, the two end battery cells 202a, 202b are electrically coupled in parallel with different intermediate battery cells 202a, 204n and the intermediate battery cells 204a, 204b, . . . , 204n are all coupled in series with each other.

As mentioned, according to embodiments herein, the row of battery cells comprises two or more remaining battery cells being electrically coupled in series with each other.

The term remaining battery cell, as used herein, may encompass a battery cell of the battery cell module 100 which is not an end battery cell 202a, 202b nor a battery cell coupled in parallel with the at least one of the two end battery cells 202a, 202b. However, also an end battery cell 202a, 202b of the battery cell module 100, as well as a battery cell coupled in parallel with the at least one of the two end battery cells 202a, 202b, may be coupled in series with one or more other battery cells of the battery cell module 100.

The term end battery cell 202a, 202b, as used herein, is intended to encompass a battery cell 202a, 202b of the battery cell module 100 which is physically placed at a distal end of the row of battery cells of the battery cell module 100. Accordingly, an end battery cell 202a, 202b of the battery cell module 100 comprises only one physically adjacent battery cell at one side of the end battery cell 202a, 202b whereas an intermediate battery cell 204a, 204b, . . . , 204n comprises two physically adjacent battery cells, i.e., one battery cell at each side of the intermediate battery cell 204a, 204b, . . . , 204n.

The row of battery cells of the battery module 100 may comprise three or more remaining battery cells being electrically coupled in series with each other. Moreover, the row of battery cells of the battery module 100 may comprise a number of remaining battery cells within the range of 2-40, or within the range of 2-26. The total number of battery cells of the battery module 100 may be within the range of 4-42, or may be within the range of 4-28.

The battery cell module 100 may comprise at least two intermediate battery cells 204a, 204b, . . . , 204n arranged between the two end battery cells 202a, 202b to form the row of battery cells, and wherein all remaining battery cells of the row of battery cells are electrically coupled in series with each other

In embodiments, at least one of the two end battery cells 202a, 202b is electrically coupled in parallel with at least one center battery cell. The stress pressure in the battery cell module 100 is usually smallest for the end battery cells 202a, 202b and largest for the center battery cells in the battery cell module 100, which may lead to a big difference in state-of-charge between the end battery cells 202a, 202b and the center battery cells if not compensated for. Thus, by coupling an end battery cell 202a; 202b in parallel with an center battery cell an efficient balancing can be achieved. The number of center battery cells depend on the number of battery cells in the battery cell module. An uneven number of battery cells leads to one center battery cells, while an even number of battery cells leads to two center battery cells. Thus, one or two end battery cells 202a, 202b may be electrically coupled in parallel to one center battery cell, one end battery cells 202a, 202b may be electrically coupled in parallel to one of two center battery cells, or two end battery cells 202a, 202b may be electrically coupled in parallel to two center battery cells, respectively.

The term center battery cell, as used herein, is intended to encompass a battery cell of the row of battery cells of the battery cell module 100 which is physically placed at a center of the row of battery cells. In embodiments in which the row of battery cells comprises an even number of battery cells, the battery cell module 100 comprises two center battery cells. In embodiments in which the row of battery cells comprises an odd/uneven number of battery cells, the battery cell module 100 comprises one center battery cell with an equal number of battery cells at the respective side of the center battery cell.

FIG. 1 and FIG. 2a schematically illustrates embodiments where the battery cell module 100 comprises an uneven number of battery cells and hence one center battery cell. In FIG. 1, one end battery cell 202a is electrically coupled in parallel to the one center battery cell. In FIG. 2a, both the end battery cells 202a, 202b are electrically coupled in parallel to the one center battery cell. The battery cell module 100 in FIG. 2b also comprises an uneven number of battery cells but the center battery cell is however not electrically coupled in parallel to any end battery cells 202a, 202b.

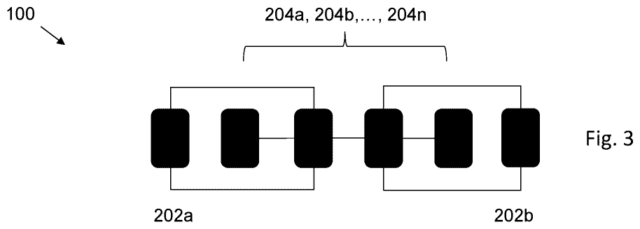

FIG. 3 schematically illustrates an embodiment where the battery cell module 100 instead comprises an even number of battery cells and hence two center battery cells. With reference to FIG. 3, the two end battery cells 202a, 202b are electrically coupled in parallel to a respective center battery cell.

In addition to the end battery cells 202a, 202b being electrically coupled in parallel with an intermediate battery cell, an intermediate battery cell may be electrically coupled in parallel with another intermediate battery cell. In embodiments, an intermediate battery cell closer to an end battery cell 202a, 202b is electrically coupled in parallel with an intermediate battery cell closer to a center battery cell.

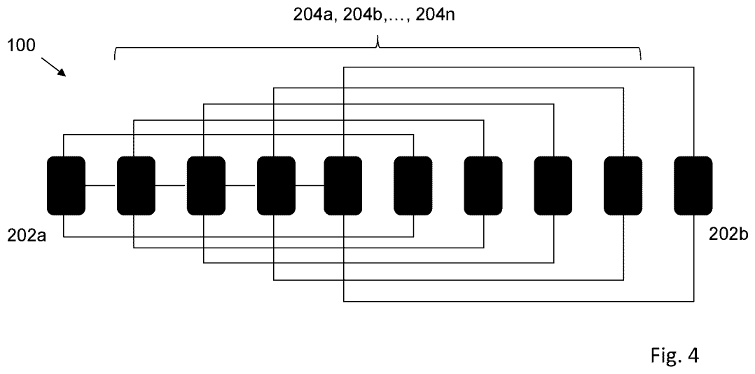

FIG. 4 schematically illustrates a battery cell module 100 according to an embodiment of the invention where each battery cells in the battery cell module 100 are electrically coupled in parallel with another battery cell such that balancing of state-of-charge is performed for all the battery cells in the battery cell module 100. With reference to FIG. 4, the row of battery cells in the battery cell module 100 comprises an even number of battery cells and hence has two center battery cells. The end battery cells 202a, 202b are electrically coupled to a respective center battery cell and intermediate battery cells closer to the end battery cells 202a, 202b are electrically coupled in parallel with intermediate battery cells closer to the center battery cells. In this way, an efficient balancing is achieved as the battery cells which potentially have the largest state-of-charge difference are coupled with each other and battery cells which potentially have smaller state-of-charge differences are coupled with each other. Thereby, optimizing the state-of-charge of the battery cells in the battery cell module 100.

Furthermore, the battery cells from one end battery cell 202a to one center battery cell is coupled in series with each other. Thus, the battery cell module 100 comprises pairs of parallel coupled battery cells, where the pairs of parallel coupled battery cells are coupled in series with each other. The number of parallel coupled battery cells determines the battery capacity of the battery cell module 100, e.g. the voltage the battery cell module can deliver. The number of parallel coupled battery cells in the battery cell module 100 is hence a design factor which affects the battery capacity the battery cell module 100 can deliver.

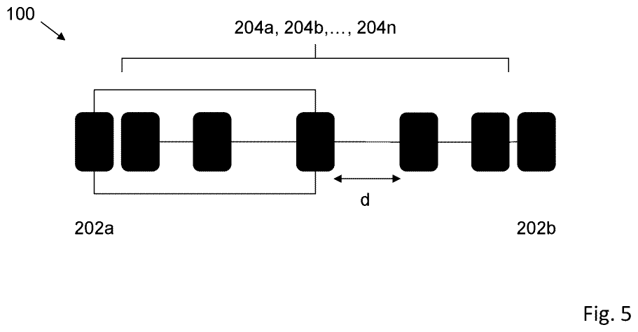

FIG. 5 schematically illustrates a battery cell module 100 according to an embodiment of the invention where a spatial distance d between two adjacent battery cells varies in the row of battery cells. In other words, the battery cells are arranged in the battery cell module such that the spatial distance d between two adjacent battery cells is not the same throughout the row of battery cells.

With reference to FIG. 5, the spatial distance d between two adjacent battery cells may depend on the distance to the end battery cells 202a, 202b. The spatial distance d between two adjacent battery cells may e.g. decrease towards the end battery cells 202a, 202b. Thus, the spatial distance d between an end battery cell 202a, 202b and the intermediate battery cell it is adjacent to may be smaller than the spatial distance d between two adjacent intermediate battery cells. The spatial distance d may in embodiments be largest in the middle of the battery cell module 100, e.g. between two center battery cells or between a center battery cell and its closest intermediate battery cell. In this way, stress interaction between the middle battery cell in the battery cell module can be reduced.

In embodiments the spatial distance between an end battery cell 202a, 202b and the intermediate battery cell it is adjacent to may e.g. be half of the spatial distance between two center battery cells or smaller. The values of the spatial distance between two adjacent battery cells may vary from a few millimetres to a few centimetres but is not limited thereto.

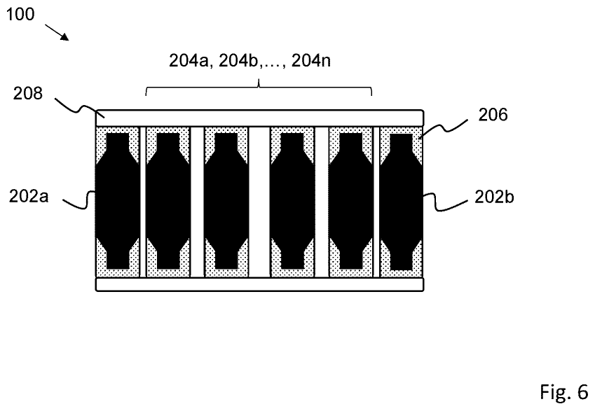

The varying spatial distance d may be implemented using battery cell holders, as schematically illustrated in FIG. 6. In the example shown in FIG. 6, the battery cell module 100 comprises battery cell holders 206 arranged in a battery cell casing 208. The battery cell holders 206 can be seen as small barriers for holding the battery cells in a specific position in the battery cell module 100 and may have one or more parts extending to partly cover an end of the battery cell. With reference to FIG. 6, the battery cell holders 206 may be fixedly attached to a top part or a bottom part of the battery cell casing 208. Thus, each battery cell may be held between an upper battery cell holder and a lower battery cell holder. The battery cell holders 206 are arranged unevenly along the battery cell casing 208, i.e. with a varying spatial distance between adjacent battery cell holders 206, to provide the varying spatial distance d between two adjacent battery cells. The battery cell holders can have different shapes and may be made of different materials such as e.g. a metal or a ceramic.

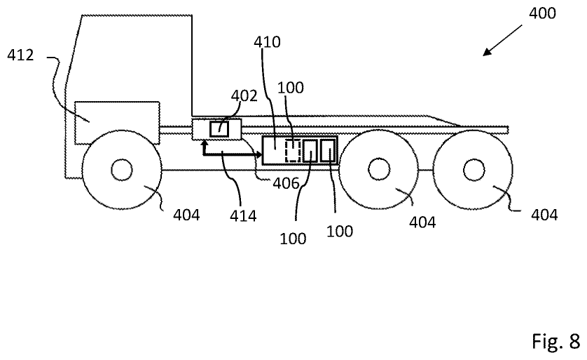

The battery cell module 100 according to any of the herein described embodiments may have two terminals, i.e. electrical contacts, for connecting the battery cell module 100 to an electrical system and/or other battery cell modules. The battery cell module 100 may e.g. be arranged with other battery cell modules into an electric battery arrangement, which may be called a battery pack. A battery pack may form the complete enclosure or unit that delivers electric power to a product or equipment, for example an electrical vehicle or a hybrid vehicle such as the vehicle 400 shown in FIG. 8.

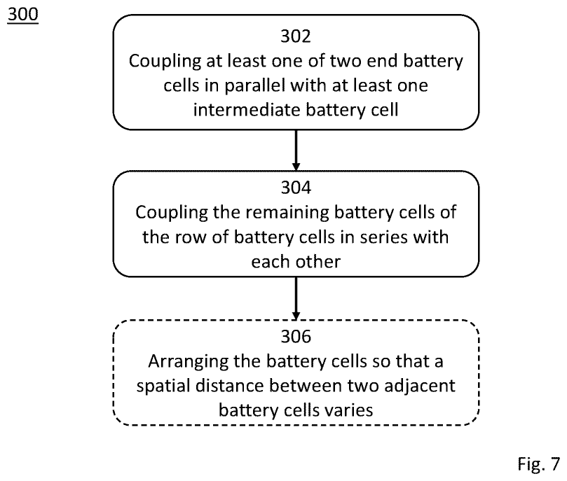

FIG. 7 schematically illustrates a flow chart of a method 300 according to an embodiment of the invention. The method 300 may be performed to couple battery cells of a battery cell module 100 comprising two end battery cells 202a, 202b and a number of intermediate battery cells 204a, 204b, . . . , 204n arranged between the two end battery cells 202a, 202b to form a row of battery cells. The battery cell module 100 may correspond to any of the herein described embodiments of the battery cell module 100. The method 300 may be performed during manufacturing or assembly of the battery cell module 100.

The method 300 comprises electrically coupling 302 least one of the two end battery cells 202a, 202b in parallel with at least one intermediate battery cell 204a, 204b, . . . , 204n and electrically coupling 304 two or more remaining battery cells of the row of battery cells in series with each other. The coupling may comprise connected the battery cells using an electrical connection means such as e.g. an electrical wire or similar.

According to some embodiments, the method 300 may comprise the step of electrically coupling all remaining battery cells of the row of battery cells of the battery module 100 in series with each other.

The method 300 may further comprises arranging 306 the battery cells so that a spatial distance between two adjacent battery cells varies in the row of battery cells. As previously described, this may be achieved by arranging the battery cells in battery cell holders in the battery cell module 100, where the battery cell holders are arranged with varying spatial distance between them.

FIG. 8 schematically illustrates a vehicle 400 according to the second aspect of the invention. In FIG. 8, the vehicle 400 is illustrated as a tractor vehicle with wheels 404. However, in other embodiments, the vehicle 400 may, for example, be a bus, a truck, or a car. Other types of vehicles are also possible. The vehicle 400 may be an electric vehicle, EV, for example a hybrid vehicle or a hybrid electric vehicle, HEV, or a battery electric vehicle, BEV.

With reference to FIG. 8, the vehicle 400 may comprise a powertrain 406, for example configured for one of an EV, HEV and BEV. The vehicle 400 comprises one or more battery cell modules 100 according to any of the herein described embodiments. The battery cell module 100 may be arranged in one or more electric battery packs 410 for the propulsion of the vehicle 400. The vehicle 400 may include one or more electric motors 402 or electrical machines, for example to propel, or drive, the vehicle 400. For example, the powertrain 406 may include the one or more electric motors 402 or electrical machines. The one or more electric motors 402 may be located in the transmission of the vehicle 400, or elsewhere in the vehicle 400. It may be defined that the powertrain 406 includes the one or more battery cell modules 100 arranged in the one or more electric battery packs 410. It is to be understood that the vehicle 400 may include further unites, components, such as electrical and/or mechanical components, a combustion engine 412 and other devices required for a vehicle 400, such as for an EV, HEV or BEV.

The vehicle 400 may further include a vehicle high voltage system 414, for example for direct current. It may be defined that the vehicle high voltage system 414 is configured for a high voltage, such as a voltage above 60 V, for example above 400 V, or above 450 V, such as above 650 V. For example, the vehicle high voltage system 414 may be configured for a voltage up to 1500 V. The electric power of the vehicle high voltage system 414 may be transferred at a high voltage, for example at one or more of the voltages levels mentioned above.

With reference to FIG. 8, the vehicle high voltage system 414 may be electrically connected to the one or more battery cell modules 100 and/or the one or more electric battery packs 410 of the vehicle 400. The one or more electric battery packs 410 may be one or more high voltage battery packs and may comprise one or more high voltage batteries arranged in the one or more battery cell modules 100. The vehicle high voltage system 414 may be configured to electrically connect the one or more electric battery packs 410 to the powertrain 406 of the vehicle 400, for example to the one or more electric motors 402 of the vehicle 400.

The present invention is not limited to the above described embodiments. Instead, the present invention relates to, and encompasses all different embodiments being included within the scope of the appended independent claim.

1. A battery cell module comprising two end battery cells and a number of intermediate battery cells arranged between the two end battery cells to form a row of battery cells, wherein at least one of the two end battery cells is electrically coupled in parallel with at least one intermediate battery cell and wherein the row of battery cells comprises two or more remaining battery cells being electrically coupled in series with each other.

2. The battery cell module according to claim 1, wherein the two end battery cells are electrically coupled in parallel with at least one intermediate battery cell.

3. The battery cell module according to claim 2, wherein the two end battery cells are electrically coupled in parallel with the same or different intermediate battery cells.

4. The battery cell module according to claim 1, wherein the battery cell module comprises at least two intermediate battery cells arranged between the two end battery cells to form the row of battery cells, and wherein all remaining battery cells of the row of battery cells are electrically coupled in series with each other.

5. The battery cell module according to claim 1, wherein at least one of the two end battery cells is electrically coupled in parallel with at least one center battery cell.

6. The battery cell module according to claim 1, wherein an intermediate battery cell closer to an end battery cell is electrically coupled in parallel with an intermediate battery cell closer to a center battery cell.

7. The battery cell module according to claim 1, wherein the row of battery cells comprises an even number of battery cells.

8. The battery cell module according to claim 1, wherein a spatial distance between two adjacent battery cells varies in the row of battery cells.

9. The battery cell module according to claim 8, wherein the spatial distance between two adjacent battery cells is dependent on the distance to the end battery cells.

10. The battery cell module according to claim 9, wherein the spatial distance between two adjacent battery cells decreases towards the end battery cells.

11. The battery cell module according to claim 1, wherein the battery cells of the battery cell module are prismatic battery cells.

12. A vehicle comprising a battery cell module, battery cell module comprising two end battery cells and a number of intermediate battery cells arranged between the two end battery cells to form a row of battery cells, wherein at least one of the two end battery cells is electrically coupled in parallel with at least one intermediate battery cell and wherein the row of battery cells comprises two or more remaining battery cells being electrically coupled in series with each other.

13. A method for coupling battery cells of a battery cell module comprising two end battery cells and a number of intermediate battery cells arranged between the two end battery cells to form a row of battery cells, the method comprising:
electrically coupling least one of the two end battery cells in parallel with at least one intermediate battery cell; and
electrically coupling two or more remaining battery cells of the row of battery cells in series with each other.

14. The method according to claim 13, wherein the method further comprises:
arranging the battery cells so that a spatial distance between two adjacent battery cells varies in the row of battery cells.

15. The method according to claim 13 comprising:
electrically coupling the two end battery cells in parallel with at least one intermediate battery cell.

16. The method according to claim 13 comprising:
electrically coupling the two end battery cells in parallel with the same or different intermediate battery cells.

17. The method according to claim 13 comprising:
electrically coupling at least one of the two end battery cells in parallel with at least one center battery cell.

18. The method according to claim 13 comprising:
electrically coupling an intermediate battery cell closer to an end battery cell in parallel with an intermediate battery cell closer to a center-battery cell.

19. The method according to claim 13 comprising:
arranging the battery cells so that a spatial distance between two adjacent battery cells is dependent on the distance to the end battery cells.

20. The method according to claim 19, wherein the spatial distance between two adjacent battery cells decreases towards the end battery cells.
